(19) United States
(12) Patent Application Publication
(10) Pub. No.: US 2026/0022062 A1
(43) Pub. Date: Jan. 22, 2026

(54) Method of Forming Pozzolan from Coal Refuse

(71) Applicants: Johnny Keith Matney, Bristol, VA (US); Justin Keith Matney, Abingdon, VA (US)

(72) Inventors: Johnny Keith Matney, Bristol, VA (US); Justin Keith Matney, Abingdon, VA (US)

(21) Appl. No.: 19/270,544

(22) Filed: Jul. 16, 2025

Related U.S. Application Data
(60) Provisional application No. 63/673,319, filed on Jul. 19, 2024.

(51) Int. Cl. C04B 7/28; C04B 7/38; C04B 7/44; C04B 18/08

(52) U.S. Cl. CPC C04B 7/28; C04B 7/38; C04B 7/44; C04B 18/08; C04B 2201/50

(57) ABSTRACT

The present disclosure is directed to a method for forming calcined pozzolan that includes: performing a gravity separation on coal refuse to separate an organic component from an inorganic component including crystalline shale; and converting the crystalline shale to a calcined pozzolan. The present disclosure also directed to a calcined pozzolan, concrete, a method of producing concrete, and a method for cleaning a landfill site.

### CROSS-REFERENCE TO RELATED APPLICATION

This application claims the benefit of U.S. Provisional Application No. 63/673,319, filed Jul. 19, 2024, the disclosure of which is hereby incorporated by reference in its entirety.

### BACKGROUND

### Field

The present disclosure relates to a method for forming pozzolan from coal refuse and the pozzolan formed therefrom.

### Technical Considerations

Coal refuse is material that is left over from coal mining and processing, such as tailings piles or spoil tips (e.g., coal waste, rock, slag, coal tailings, waste material, rock bank, culm, boney, or garbage of bituminous (GOB)). The coal refuse may comprise an organic component and an inorganic component comprising crystalline shale. For every ton of coal generated, significant waste material is also generated.

Throughout the United States, piles of coal refuse remain in abandoned piles where coal mining and washing operations have ceased. Some of these piles are hundreds of feet deep and can be viewed from space. These conventional methods of landfilling coal refuse consume valuable land and cause adverse impacts, such as rainwater runoff, soil, and ground pollution. They also present a “forever source” of uncontrolled air emissions, including greenhouse gases and fugitive air pollutants.

Discussions regarding how to best remediate these piles of coal refuse continue. Resources have been consistently appropriated to address flare-ups of spontaneous combustion of a reactive response, without a solution to eliminate the piles causing the harm.

### SUMMARY

The present disclosure relates to methods of forming calcined pozzolan from these piles of coal refuse, the calcined pozzolan formed therefrom, a method of cleaning landfills containing coal refuse, concrete containing the calcined pozzolan, and methods of producing concrete and concrete products.

According to non-limiting embodiments or aspects, a method for forming calcined pozzolan includes: performing a gravity separation on coal refuse to separate an organic component from an inorganic component including crystalline shale; and converting the crystalline shale to a calcined pozzolan.

In some non-limiting embodiments or aspects, the converting may include flash calcining the crystalline shale at a temperature of from 750° C. to 950° C. to convert the crystalline shale to calcined pozzolan.

In some non-limiting embodiments or aspects, the converting may include kilning the crystalline shale at a temperature of from 750° C. to 950° C. to convert the crystalline shale to calcined pozzolan.

In some non-limiting embodiments or aspects, the calcined pozzolan may be capable of chemically reacting with calcium hydroxide in the presence of moisture at ambient temperature.

In some non-limiting embodiments or aspects, the calcined pozzolan may include silica (SiO₂) and alumina (Al₂O₃).

In some non-limiting embodiments or aspects, the method may further include: before the converting, milling the crystalline shale to an average particle size of 1 mm or less.

In some non-limiting embodiments or aspects, the method may further include: pulverizing the organic component; and the converting including combusting the pulverized organic component with fuel to heat the crystalline shale.

In some non-limiting embodiments or aspects, the coal refuse may be sourced from a landfill.

In some non-limiting embodiments or aspects, the calcined pozzolan may include a siliceous or siliceous and aluminous material that, in the presence of moisture and at ambient temperature, reacts with calcium hydroxide (CH) to form calcium silicate hydrate (CSH).

According to non-limiting embodiments or aspects, a method for cleaning a landfill site includes: collecting coal refuse accumulated at the landfill site; and converting the coal refuse to a calcined pozzolan material according to the method described herein.

In some non-limiting embodiments or aspects, the method may further include: removing the coal refuse and/or the calcined pozzolan material converted from the coal refuse from the landfill site.

According to non-limiting embodiments or aspects, a calcined pozzolan is formed from the method described herein.

According to non-limiting embodiments or aspects, a concrete and/or a concrete product includes cement and the calcined pozzolan described herein.

In some non-limiting embodiments or aspects, the calcined pozzolan may react with calcium hydroxide (CH) of the concrete to form calcium silicate hydrate (CSH).

In some non-limiting embodiments or aspects, the concrete may include: from 70-95 weight percent cement; and from 5-30 weight percent supplementary cementitious material including the calcined pozzolan.

In some non-limiting embodiments or aspects, the supplementary cementitious material may consist of the calcined pozzolan.

In some non-limiting embodiments or aspects, the supplementary cementitious material may include the calcined pozzolan mixed with fly ash and/or bottom ash.

In some non-limiting embodiments or aspects, the cement may include T-IL cement.

According to non-limiting embodiments or aspects, a method of producing concrete includes mixing cement with the calcined pozzolan described herein.

In some non-limiting embodiments or aspects, the calcined pozzolan may react with calcium hydroxide (CH) of the concrete to form calcium silicate hydrate (CSH).

According to non-limiting embodiments or aspects, a concrete includes cement and a supplementary cementitious material including calcined pozzolan, the concrete having: a 7-day strength activity index of at least 70; a 28-day strength activity index of at least 75; a water requirement of up to 105; and/or a loss on ignition of up to 4.0, where the 7-day strength activity index, the 28-day strength activity index, and the water requirement are determined relative to the same concrete except not including the supplementary cementitious material.

Further non-limiting embodiments or aspects are set forth in the following numbered clauses:

Clause 1: A method for forming calcined pozzolan, comprising: performing a gravity separation on coal refuse to separate an organic component from an inorganic component comprising crystalline shale; and converting the crystalline shale to a calcined pozzolan.

Clause 2: The method of clause 1, wherein the converting comprises flash calcining the crystalline shale at a temperature of from 750° C. to 950° C. to convert the crystalline shale to calcined pozzolan.

Clause 3: The method of clause 1 or 2, wherein the converting comprises kilning the crystalline shale at a temperature of from 750° C. to 950° C. to convert the crystalline shale to calcined pozzolan.

Clause 4: The method of any of clauses 1-3, wherein the calcined pozzolan is capable of chemically reacting with calcium hydroxide in the presence of moisture at ambient temperature.

Clause 5: The method of any of clauses 1-4, wherein the calcined pozzolan comprises silica (SiO₂) and alumina (Al₂O₃).

Clause 6: The method of any of clauses 1-5, further comprising: before the converting, milling the crystalline shale to an average particle size of 1 mm or less.

Clause 7: The method of any of clauses 1-6, further comprising: pulverizing the organic component; and the converting comprising combusting the pulverized organic component with fuel to heat the crystalline shale.

Clause 8: The method of any of clauses 1-7, wherein the coal refuse is sourced from a landfill.

Clause 9: The method of any of clauses 1-8, wherein the calcined pozzolan comprises a siliceous or siliceous and aluminous material that, in the presence of moisture and at ambient temperature, reacts with calcium hydroxide (CH) to form calcium silicate hydrate (CSH).

Clause 10: A method for cleaning a landfill site, comprising: collecting coal refuse accumulated at the landfill site; and converting the coal refuse to a calcined pozzolan material according to the method of any of clauses 1-9.

Clause 11: The method of clause 10, further comprising: removing the coal refuse and/or the calcined pozzolan material converted from the coal refuse from the landfill site.

Clause 12: Calcined pozzolan formed from the method of any of clauses 1-9.

Clause 13: Concrete and/or a concrete product comprising cement and the calcined pozzolan of clause 12.

Clause 14: The concrete of clause 13, wherein the calcined pozzolan reacts with calcium hydroxide (CH) of the concrete to form calcium silicate hydrate (CSH).

Clause 15: The concrete of clause 13 or 14, wherein the concrete comprises: from 70-95 weight percent cement; and from 5-30 weight percent supplementary cementitious material comprising the calcined pozzolan.

Clause 16: The concrete of clause 15, wherein the supplementary cementitious material consists of the calcined pozzolan.

Clause 17: The concrete of clause 15, wherein the supplementary cementitious material comprises the calcined pozzolan mixed with fly ash and/or bottom ash.

Clause 18: The concrete of any of clauses 15-17, wherein the cement comprises T-IL cement.

Clause 19: A method of producing concrete comprising mixing cement with the calcined pozzolan of clause 12.

Clause 20: The method of clause 19, wherein the calcined pozzolan reacts with calcium hydroxide (CH) of the concrete to form calcium silicate hydrate (CSH).

Clause 21: Concrete comprising cement and a supplementary cementitious material comprising calcined pozzolan, the concrete having: a 7-day strength activity index of at least 70; a 28-day strength activity index of at least 75; a water requirement of up to 105; and/or a loss on ignition of up to 4.0, wherein the 7-day strength activity index, the 28-day strength activity index, and the water requirement are determined relative to the same concrete except not including the supplementary cementitious material.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 shows a step diagram of a method for forming pozzolan from coal refuse, according to non-limiting embodiments or aspects of the present disclosure;

FIG. 2 shows a system for producing concrete from pozzolan, according to non-limiting embodiments or aspects of the present disclosure; and

FIGS. 3A and 3B show a landfill containing coal refuse (FIG. 3A) and a cleaned landfill (FIG. 3B), according to non-limiting embodiments or aspects of the present disclosure.

### DETAILED DESCRIPTION

For purposes of the following detailed description, it is understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in its respective testing measurement.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

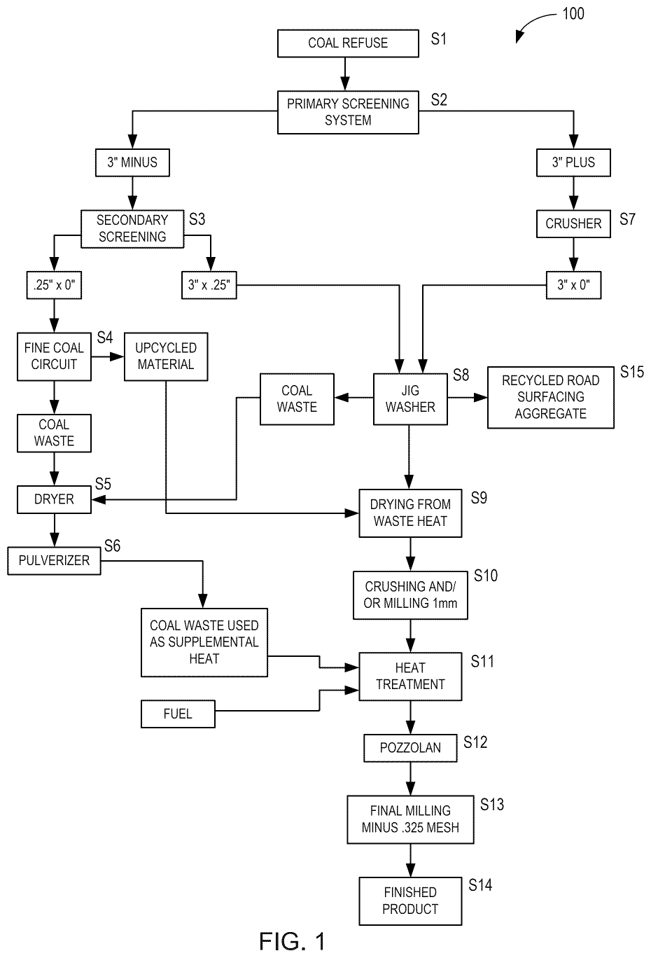

Referring to FIG. 1, a method 100 is shown for forming pozzolan (e.g., a calcined pozzolan) from coal refuse. Non-limiting steps of the method are described in detail hereinafter.

At a step S1, a coal refuse may be provided, which may comprise coal processing waste and/or raw mine waste. The coal refuse may comprise a byproduct from a coal preparation plant that washes coal from soil and/or rock (e.g., GOB waste). The coal refuse may comprise an organic component (e.g., hydrocarbon containing component) and an inorganic component comprising crystalline shale rock and optionally other inorganic mineral and/or rock components. The coal refuse may be sourced from a landfill site storing the coal refuse as a waste material.

At a step S2, the coal refuse may be fed into a screen system, such as a primary double deck screening system. The screen system may separate the coal refuse into at least two sizes. As a non-limiting example, the coal refuse may be separated into the following two sizes: (1) coal refuse having a particle size of from 0″ to 3″ (3″ minus); and (2) coal refuse having a particle size of from 3″ to 16″ (3″ plus). For example, the screening system may comprise a stack of screens having a top screen having 16″×16″ openings, a middle screen having 3″×3″ openings, and a bottom pan (having 0″ openings). The coal refuse having a particle size of from 0″ to 3″ (smaller particles) may be fed to step S3. The coal refuse having a particle size of from 3″ to 16″ (larger particles) may be fed to step S7.

At a step S3, the coal refuse having a particle size of from 0″ to 3″ (smaller particles from step S2) may be further screened. The screen system in step S3 may separate the coal refuse into at least two sizes. As a non-limiting example, the coal refuse may be separated into the following two sizes: (1) coal refuse having a particle size of from 0″ to 0.25″; and (2) coal refuse having a particle size of from 0.25″ to 3″. The coal refuse having a particle size of from 0″ to 0.25″ (smaller particles) may be fed to step S4. The coal refuse having a particle size of from 0.25″ to 3″ (larger particles) may be fed to step S8.

At a step S7, the coal refuse having a particle size of from 3″ to 16″ (larger particles from step S2) may be crushed to form coal refuse having smaller particle sizes. The crushed coal refuse may be screened by a 3″×0″ screen system so that the material passing through the 3″ screen is fed to step S8.

At a step S4, the fine coal refuse having a particle size of from 0″ to 0.25″ (smaller particles from step S3) may be fed to a fine coal circuit, which may gravity separate the material fed thereto (e.g., perform a process similar to the jig washer in step S8). The fine coal circuit may comprise a gravity separator that separates lighter particles (e.g., predominantly organic (e.g., carbon particles) from heavier particles (e.g., predominantly inorganic (e.g., crystalline shale rock, minerals, and/or other rock) particles). The lighter, organic particles may comprise coal waste that is fed to a dryer step S5. The heavier particles may comprise upcycle material that is fed to step S9.

At a step S5, the lighter particles of predominantly organic materials (coal waste) dried in step S5 may be pulverized in step S6, resulting in a coal waste that can be used as supplemental heat. The pulverized organic component may be combusted with fuel to heat the crystalline shale in the heat treatment (e.g., flash calcining and/or kilning) (e.g., step S11). Thus, the organic component of the coal refuse that cannot be converted to pozzolan may nonetheless be used as an energy input used for converting the shale to pozzolan.

At a step S8, the coal refuse (from step S3 and/or step S7) may be fed to a jig washer. The jig washer may comprise a gravity separator, which may comprise a screen that is pulsed vertically with water to separate the material into a heavier component that passes through the screen and a lighter component that remains on top of the screen. The jig washer may separate the input material into at least 3 separate components. As a non-limiting example, the 3 separate components may comprise: (1) the smallest component comprising predominantly organic (e.g., hydrocarbon containing) material (e.g., coal waste), which may be fed to dryer step S5; (2) the largest component comprising heavy, dense rock heavier than the crystalline shale (e.g., sandstone), which component may be fed to step S15 to be used as recycled road surfacing aggregate or for other applications; and (3) the medium component comprising predominantly crystalline shale material, which may be fed to step S9. Thus, in step S8, a gravity separation on coal refuse may be performed to separate an organic component from an inorganic component comprising crystalline shale.

At a step S9, the crystalline shale component from the jig washer (step S8) may be combined with the upcycle material, which may also be predominantly crystalline shale, and the material may be dried from waste heat.

At a step S10, before the crystalline shale is converted to pozzolan, the dried material from step S9 may be crushed and/or milled. The crystalline shale in step S10 may be crushed and/or milled to an average particle size of 1 mm or less, or to any particle size suitably handled in step S11. The crushed/milled material may be fed to step S11.

At a step S11, the crystalline shale may be converted to a pozzolan material (e.g., a calcined pozzolan material). For example, the crystalline shale may be converted to a calcined pozzolan material by a heat treatment, and step S11 may comprise a heating component that applies the heat treatment. For example, the heating component may comprise a calciner (e.g., a flash calciner) configured to calcine the crystalline shale at a temperature of from 750° C. to 950° C. to convert the crystalline shale to calcined pozzolan. For example, alternatively, the heating component may comprise a kiln (e.g., rotary kiln) configured to kiln the crystalline shale at a temperature of from 750° C. to 950° C. to convert the crystalline shale to calcined pozzolan.

An industrial gas may be a fuel (e.g. natural gas). The fuel may be used to combust the pulverized organic component (from step S6) to heat the crystalline shale in the heating component of step S11.

At a step S12, the pozzolan formed in step S11 may be collected.

At a step S13, the collected pozzolan may be further milled to a particle size suitable to being combined with cement (e.g., as an additive to concrete and/or a concrete product). For example, the pozzolan may be milled to pass through a −325 mesh (e.g., 44 micron).

At a step S14, the finished product in step S14 may be a milled pozzolan capable of chemically reacting with calcium hydroxide in the presence of moisture at ambient temperature, milled to a size configured to be mixed with cement. Ambient temperature may refer to a room or outdoor temperature (e.g., from 0° F.-120° F. (−18° C.-49° C.)).

As defined in American Concrete Institute (ACI) 116R, pozzolan may include a siliceous or siliceous and aluminous material, which in itself possesses little or no cementitious value but will (e.g., in finely divided form), in the presence of moisture, chemically react with calcium hydroxide at ordinary (e.g., ambient) temperatures to form compounds possessing cementitious properties. In the present disclosure, calcined pozzolan may refer to a pozzolan formed by intentionally heating (e.g., with a calciner and/or a kiln) crystalline shale to release the volatile components and thermally activate the reactivity such that the resulting material is capable of reacting with calcium hydrate at ambient temperature. The heating to form calcined pozzolan may be at a temperature of from 750° C. to 950° C. Pozzolan is not simply a mitigator against chemical attacks but may also function as a transformer that repurposes deleterious calcium hydroxide into a cementitious compound that magnifies performance.

The pozzolan material produced by the foregoing process may comprise silica (SiO₂) or silica and alumina (Al₂O₃) (a siliceous or siliceous and aluminous material), which material may, in the presence of moisture and at ambient temperature, react with calcium hydroxide (CH) to form calcium silicate hydrate (CSH).

In some non-limiting embodiments or aspects, the pozzolan may comprise the following ranges for each potential component of the pozzolan:

| | | Wt % (Ignited |
|---|---|---|
| Component | | Basis) |
| Silica | SiO₂ | 50-100 |
| Alumina | Al₂O₃ | 0-50 |
| Titanium dioxide | TiO₂ | 0-5 |
| Iron oxide | Fe₂O₃ | 0-10 |
| Calcium oxide | CaO | 0-5 |
| Magnesium oxide | MgO | 0-5 |
| Potassium oxide | K2O | 0-5 |
| Sodium oxide | Na₂O | 0-1 |
| Sulfur trioxide | SO₃ | 0-1 |
| Phosphorus | P₂O₅ | 0-1 |
| pentoxide | | |
| Strontium oxide | SrO | 0-1 |
| Barium oxide | BaO | 0-1 |
| Manganese oxide | MnO | 0-1 |

| | |
|---|---|
| Other | 0-1 |

Thus, the process shown and described in FIG. 1 may process a coal refuse pile that otherwise is a pollutant and converts it into a useful pozzolan material.

The pozzolan produced according to methods described herein may be mixed with cement to form concrete. The pozzolan may react with calcium hydroxide (CH) of the concrete to form calcium silicate hydrate (CSH), thus strengthening the concrete (compared to the same concrete except prepared without pozzolan). Thus, the present disclosure is directed to a concrete comprising the pozzolan as described herein.

The concrete comprising the pozzolan may comprise from 5-30 weight percent supplementary cementitious material comprising the pozzolan, based on total weight of the concrete, such as from 5-25 weight percent, 5-20 weight percent, 10-30 weight percent, 10-25 weight percent, or 10-20 weight percent. The concrete comprising the pozzolan may comprise at least 5 weight percent supplementary cementitious material comprising the pozzolan, based on total weight of the concrete, such as at least 10 weight percent or at least 15 weight percent. The concrete comprising the pozzolan may comprise up to 30 weight percent supplementary cementitious material comprising the pozzolan, based on total weight of the concrete, such up to 25 weight percent.

The concrete comprising the pozzolan may comprise from 5-30 weight pozzolan, based on total weight of the concrete, such as from 5-25 weight percent, 5-20 weight percent, 10-30 weight percent, 10-25 weight percent, or 10-20 weight percent. The concrete comprising the pozzolan may comprise at least 5 weight percent pozzolan, based on total weight of the concrete, such as at least 10 weight percent or at least 15 weight percent. The concrete comprising the pozzolan may comprise up to 30 weight percent pozzolan, based on total weight of the concrete, such up to 25 weight percent.

In some non-limiting embodiments or aspects, the supplementary cementitious material consists of the pozzolan.

In some non-limiting embodiments or aspects, the supplementary cementitious material may comprise a blend of pozzolan with other supplementary cementitious material. For example, the pozzolan may be blended with at least one of the following: fly ash, bottom ash, metakaolin, silica fume, slag, and/or any combination thereof. Supplemental cementitious material may refer to mineral additions that react chemically and/or physically with cement, such as pozzolan, fly ash, bottom ash, metakaolin, silica fume, slag, and/or any combination thereof.

The concrete comprising the pozzolan may comprise from 70-95 weight percent cement, based on total weight of the concrete, such as from 75-95 weight percent, 80-95 weight percent, 70-90 weight percent, 75-90 weight percent, or 80-90 weight percent. The concrete comprising the pozzolan may comprise at least 70 weight percent cement, based on total weight of the concrete, such as at least 75 weight percent or at least 80 weight percent. The concrete comprising the pozzolan may comprise up to 95 weight percent cement, based on total weight of the concrete, such up to 90 weight percent, up to 85 weight percent, or up to up to 80 weight percent.

The cement of the concrete may be any suitable cement, such as at least one of the following: Type T-I/II cement, Type T-IL cement, and/or any combination thereof. The cement may comprise and/or consist of Type T-IL cement. The cement mixed with pozzolan may comprise Portland cement.

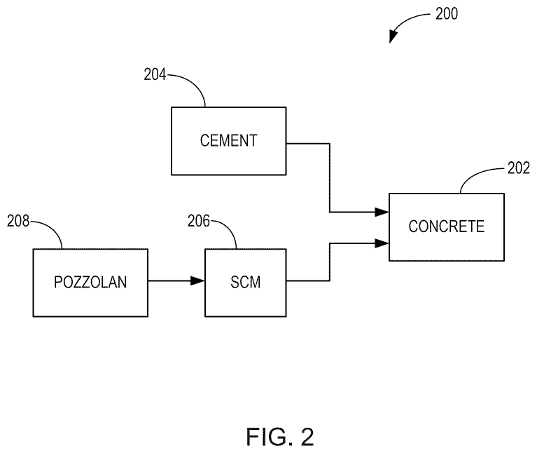

Referring to FIG. 2, a system 200 is shown for producing concrete from pozzolan. In system 200, concrete 202 may be produced by mixing cement 204 with supplementary cementitious material 206. Supplementary cementitious material 206 may include pozzolan 208 optionally mixed with other supplementary cementitious materials as described herein. Thus, producing concrete 202 may comprise mixing cement 204 with pozzolan 208.

In production of cement, calcium hydroxide may be produced as a byproduct of cement hydration. The pozzolan may react with this calcium hydroxide byproduct to form calcium silicate hydrate. This pozzolanic reaction may be a secondary reaction to the primary reaction of cement and water. The calcium silicate hydrate may function as a glue that binds concrete aggregate.

The concrete produced from cement and a supplementary cementitious material comprising pozzolan may comprise at least one of the following: a 7-day strength activity index of at least 70; a 28-day strength activity index of at least 75; a water requirement of up to 105; a loss on ignition of up to 4.0, and/or any combination thereof. The 7-day strength activity index, the 28-day strength activity index, and the water requirement may be determined relative to the same concrete except not including the supplementary cementitious material (e.g., from 100% cement concrete).

The concrete may have a 7-day strength activity index of at least 70, such as at least 80, at least 85, at least 90, or at least 95.

The concrete may have a 28-day strength activity index of at least 75, such as at least 80, at least 85, at least 90, at least 95, at least 97, or at least 98.

The concrete may have a water requirement of up to 105, such as up to 104, up to 103, up to 102, or up to 101.

The concrete may have a loss on ignition of up to 4.0, such as up to 3.9, up to 3.7, or up to 2.0.

The concrete produced using the pozzolan may have (compared to the same concrete except not using the pozzolan) improved resistance to chemical attacks, reduced permeability, and/or improved durability.

Regarding the improved resistance to chemical attacks, when calcium hydroxide migrates out of concrete's interior via capillary action, it leaves behind a maze of porosity that weakens the concrete and allows for ingress of water. The water can contain sulfates, chlorides, and other damaging chemicals. In cold climates, the water penetrating the pores may freeze and cause freeze-thaw damage to the concrete. Not all of the calcium hydroxide may migrate out of the concrete, and what remains may combine or react with other chemicals. However, by using pozzolan in the concrete, the pozzolan effectively consumes the problem causing calcium hydroxide. The pozzolan-containing concrete may be highly sulfate resistant.

The presence of the pozzolan may lower the heat generated during cement hydration, thus minimizing the risk of thermal cracking. For example, the heat of hydration may be reduced by from 10%-40% during the first 100 hours, depending on the mix design. After 100 hours, the cement-water hydration process may wane while the pozzolan mixes continue to hydrate until one of the two remaining hydration agents (calcium hydroxide or pozzolan) have been consumed. This slow pozzolanic hydration process can continue for months or even years, bringing the long term strength of the pozzolan-containing concrete well beyond that of ordinary cement concrete.

The concrete produced using the pozzolan may have a fortified resistivity to penetration by liquids and/or gasses that may corrode the steel reinforcing the concrete. For example, chloride penetration can cause reinforcing steel embedded in the concrete to corrode, ultimately causing concrete failure by expansion of the iron oxide hydrate (rust). The pozzolan may improve the packing density of the matrix, such that the liquids and/or gasses that may cause corrosion cannot penetrate the concrete.

The pozzolan may also help reduce expansion and damage caused by alkali-silica reaction (ASR). As the concrete hardens, the pozzolan may react with calcium hydroxide, trapping any alkali inside the densifying cement paste. This may reduce or eliminate alkali-silica reactions and efflorescence. Moreover, pozzolan-blended cements may have enhanced resistance to ASR. The pozzolan may reduce or eliminate efflorescence (a white powdery substance that can form on the surface of concrete).

Concretes produced with Portland cement can involve the burning of limestone at high temperatures, which process can consume a large amount of carbon-based fuels. As the limestone is heated, it releases carbon dioxide into the atmosphere to form lime. Pozzolan can replace at least a portion of the Portland cement (e.g., up to 40 weight percent) as a supplementary cementitious material. This replacement of Portland cement with pozzolan can reduce the cement's carbon footprint while also enhancing properties of the resulting cement as described herein.

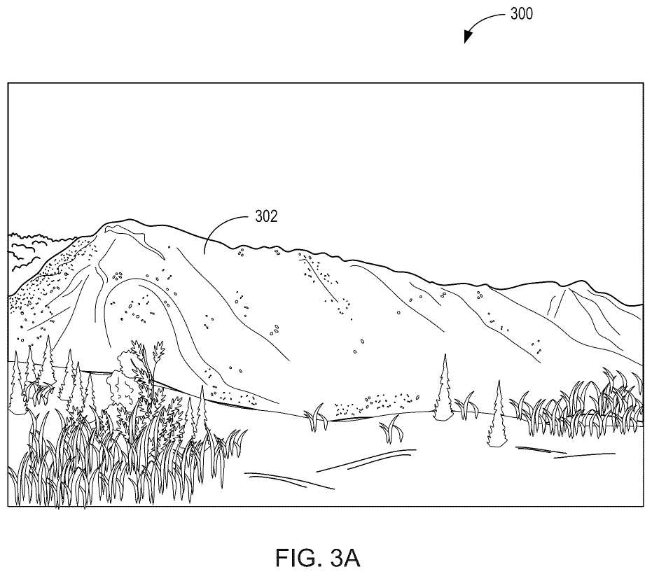

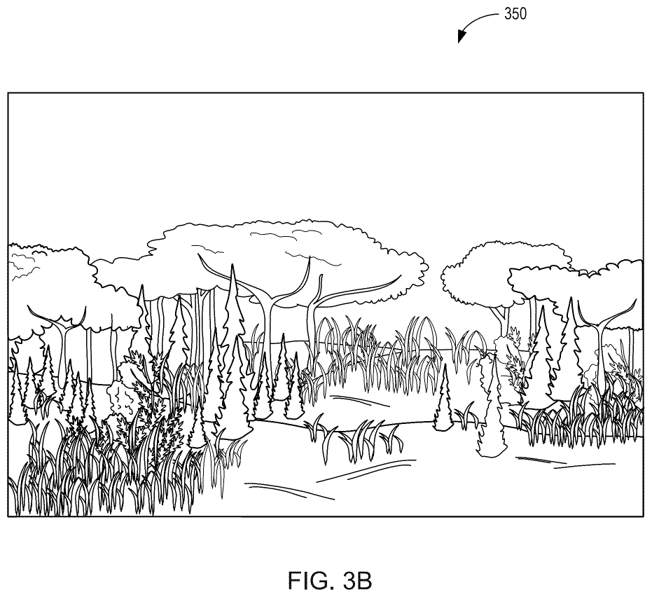

FIGS. 3A and 3B show a landfill containing coal refuse (FIG. 3A) and a cleaned landfill (FIG. 3B), according to non-limiting embodiments or aspects of the present disclosure.

Referring to FIG. 3A, a landfill site 300 is shown comprising at least one pile 302 of accumulated coal refuse. Referring to FIG. 3B, a cleaned landfill site 350 is shown, which is landfill site 300 from FIG. 3A cleaned by remediating pile 302 of accumulated coal refuse.

Landfill site 300 may be cleaned to form cleaned landfill site 350 by collecting coal refuse accumulated at landfill site 300. The collected coal refuse may be converted into a pozzolan material according to any of the methods described herein (e.g., from FIG. 1).

In some non-limiting embodiments or aspects, the coal refuse may be converted into the pozzolan at landfill site 300. The pozzolan may be removed from landfill site 300 to clean landfill site 300.

In some non-limiting embodiments or aspects, the coal refuse may be removed from landfill site 300 to clean landfill site 300. The coal refuse may be converted into the pozzolan at a site different from landfill site 300.

Cleaned landfill site 350 may have at least 95 percent (e.g., by weight) of the coal refuse removed, compared to the amount of coal refuse originally at landfill site 300, such as at least 98 percent, at least 99 percent, or 100 percent.

Thus, the method for cleaning a landfill site as described herein may enable remediation of tons of waste coal refuse by converting the waste product into a use pozzolan product that can improve certain properties when used to form concrete. The method may further yield a net reduction of greenhouse gas emissions by substituting the pozzolan for fly ash or other produced and calcined additives used in concrete. This reduction in greenhouse gas emissions may be an additional 33% at the point of mixing. Still further, cleaned landfill site 350 may return the spoiled terrain (e.g., landfill site 300) to its original environmental condition.

### EXAMPLES

### Preparation of Concrete Containing Pozzolan

Comparative Example 1 was prepared using 100 weight percent of type T-IL cement.

Examples 2-10 were prepared by mixing 80 weight percent of type T-IL cement with 20 weight percent of a supplementary cementitious material (SCM). The SCM for Examples 2-10 were as follows.

Example 2: Pozzolan formed from thermally treating shale at 750° C. for 2 hours.

Example 3: Pozzolan formed from thermally treating shale at 750° C. for 4 hours.

Example 4: Pozzolan formed from thermally treating shale at 750° C. for 8 hours.

Example 5: Pozzolan formed from thermally treating shale at 800° C. for 2 hours.

Example 6: Pozzolan formed from thermally treating shale at 800° C. for 4 hours.

Example 7: Pozzolan formed from thermally treating shale at 800° C. for 8 hours.

Example 8: A 70/30 blend of fly ash with the Pozzolan of Example 6.

Example 9: A 70/30 blend of bottom ash with the Pozzolan of Example 6.

Example 10: A 70/30 blend of milled bottom ash with the Pozzolan of Example 6.

Properties of the resulting concrete are shown in the following Table 1:

TABLE 1

| | | Cement | | | | | | | | |
|---|---|---|---|---|---|---|---|---|---|---|
| | | T-IL | SCM | | 7 d | 7 d | 28 d | 28 d | H₂O | |
| Example | D50¹ | Wt % | %² | W/C³ | PSI⁴ | SAI⁵ | PSI⁶ | SAI⁷ | Req.⁸ | LOI⁹ |
| CE1 | — | 100 | 0 | 0.484 | 5318 | 100 | 7029 | 100 | — | — |
| Ex. 2 | 22 | 80 | 20 | 0.484 | 4473 | 84 | 6232 | 89 | 103 | 3.9 |
| Ex. 3 | 18 | 80 | 20 | 0.484 | 5063 | 95 | 6860 | 98 | 105 | 3.9 |
| Ex. 4 | 16 | 80 | 20 | 0.484 | 5365 | 100 | 6897 | 98 | 105 | 3.9 |
| Ex. 5 | 23 | 80 | 20 | 0.484 | 4736 | 89 | 6378 | 91 | 101 | 3.7 |
| Ex. 6 | 18 | 80 | 20 | 0.484 | 5050 | 95 | 6809 | 97 | 101 | 3.7 |
| Ex. 7 | 15 | 80 | 20 | 0.484 | 5019 | 94 | 6855 | 98 | 102 | 3.7 |
| Ex. 8 | — | 80 | 20 | 0.484 | 4775 | 90 | 7003 | 100 | 102 | 1.81 |
| Ex. 9 | — | 80 | 20 | 0.484 | 3908 | 73 | 5585 | 79 | 102 | 1.71 |
| Ex. 10 | — | 80 | 20 | 0.484 | 4536 | 85 | 5993 | 85 | 101 | 1.74 |

¹D50 particle size of the pozzolan as determined by a Malvern Laser-Diffraction Analyzer
²Supplementary cementitious material @ 20% replacement as per ASTM C311
³Water to cement ratio- mass of water/mass of cementitious material
⁴7 day compressive strength in pounds per square inch
⁵7 day Strength Activity Index (SAI)- compressive strength at 7 days/7 day compressive strength of cement
⁶28 day compressive strength in pounds per square inch
⁷28 day Strength Activity Index (SAI)- compressive strength at 28 days/28 day compressive strength of cement
⁸Water demand of a blend - 80% Cement + 20% Pozzolan - compared to 100% Cement Index
⁹Loss on ignition (LOI) as determined by a thermogravimetric analysis (TGA) analyzer

As can be seen from Table 1, the concretes containing pozzolan exhibited comparatively similar properties relative to Comparative Example 1 containing 100% cement, and the values of the reported properties satisfy the guidelines for ASTM C311 and/or C618-23 certification.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method for forming calcined pozzolan, comprising:
performing a gravity separation on coal refuse to separate an organic component from an inorganic component comprising crystalline shale; and
converting the crystalline shale to calcined pozzolan.

2. The method of claim 1, wherein the converting comprises flash calcining the crystalline shale at a temperature of from 750° C. to 950° C. to convert the crystalline shale to calcined pozzolan.

3. The method of claim 1, wherein the converting comprises kilning the crystalline shale at a temperature of from 750° C. to 950° C. to convert the crystalline shale to calcined pozzolan.

4. The method of claim 1, wherein the calcined pozzolan is capable of chemically reacting with calcium hydroxide in the presence of moisture at ambient temperature.

5. The method of claim 1, wherein the calcined pozzolan comprises silica (SiO₂) and alumina (Al₂O₃).

6. The method of claim 1, further comprising:
before the converting, milling the crystalline shale to an average particle size of 1 mm or less.

7. The method of claim 1, further comprising:
pulverizing the organic component; and
the converting comprising combusting the pulverized organic component with fuel to heat the crystalline shale.

8. The method of claim 1, wherein the coal refuse is sourced from a landfill.

9. The method of claim 1, wherein the calcined pozzolan comprises a siliceous or siliceous and aluminous material that, in the presence of moisture and at ambient temperature, reacts with calcium hydroxide (CH) to form calcium silicate hydrate (CSH).

10. A method for cleaning a landfill site, comprising:
collecting coal refuse accumulated at the landfill site; and
converting the coal refuse to a calcined pozzolan material according to the method of claim 1.

11. The method of claim 10, further comprising:
removing the coal refuse and/or the calcined pozzolan material converted from the coal refuse from the landfill site.

12. Calcined pozzolan formed from the method of claim 1.

13. Concrete and/or a concrete product comprising cement and the calcined pozzolan of claim 12.

14. The concrete of claim 13, wherein the calcined pozzolan reacts with calcium hydroxide (CH) of the concrete to form calcium silicate hydrate (CSH).

15. The concrete of claim 13, wherein the concrete comprises:
from 70-95 weight percent cement; and
from 5-30 weight percent supplementary cementitious material comprising the calcined pozzolan.

16. The concrete of claim 15, wherein the supplementary cementitious material consists of the calcined pozzolan.

17. The concrete of claim 15, wherein the supplementary cementitious material comprises the calcined pozzolan mixed with fly ash and/or bottom ash.

18. The concrete of claim 15, wherein the cement comprises T-IL cement.

19. A method of producing concrete comprising mixing cement with the calcined pozzolan of claim 12.

20. Concrete comprising cement and a supplementary cementitious material comprising calcined pozzolan, the concrete having:
a 7-day strength activity index of at least 70;
a 28-day strength activity index of at least 75;
a water requirement of up to 105; and/or
a loss on ignition of up to 4.0,
wherein the 7-day strength activity index, the 28-day strength activity index, and the water requirement are determined relative to the same concrete except not including the supplementary cementitious material.
